(19) United States
(12) Patent Application Publication
(10) Pub. No.: US 2007/0108898 A1
(43) Pub. Date: May 17, 2007

(54) Organic electroluminescence device

(75) Inventors: Masahide Matsuura, Sodegaura-shi (JP); Hideaki Nagashima, Sodegaura-shi (JP); Hidetsugu Ikeda, Sodegaura-shi (JP); Toshihiro Iwakuma, Sodegaura-shi (JP); Hiroaki Nakamura, Sodegaura-shi (JP); Tadashi Kusumoto, Sodegaura-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/512,110

(22) Filed: Aug. 30, 2006

(30) Foreign Application Priority Data
Aug. 30, 2005 (JP) 2005-249000

(51) Int. Cl. H01J 1/62

(52) U.S. Cl. 313/506; 313/507

(57) ABSTRACT

An organic electroluminescent device (1) comprising: an anode (20), a cathode (70) and a plurality of layers comprising at least a hole-injecting-transporting layer (30) in contact with the anode (20) and an emitting layer. (40), the plurality of layers being provided between the anode (20) and the cathode (70), a difference in ionization potential between the hole-injecting-transporting layer (30) and the anode (20) being more than 0.7 eV.

### TECHNICAL FIELD

The invention relates to an organic electroluminescent device.

### BACKGROUND ART

An organic electroluminescent device (EL) using an organic substance is a promising solid-state emitting type inexpensive and large full-color display device. Accordingly, the organic EL device has been extensively developed. In general, an organic EL device includes an emitting layer and a pair of opposing electrodes holding the emitting layer therebetween. When an electric field is applied between the electrodes, electrons are injected from the cathode and holes are injected from the anode. The electrons recombine with the holes in the emitting layer to produce an excited state, and energy is emitted as light when the excited state returns to the ground state.

Various organic EL devices have been known. For example, patent document 1 discloses an organic EL device having a device configuration of indium tin oxide (ITO)/hole transporting layer/emitting layer/cathode, in which an aromatic tertiary amine is used as the material for the hole transporting layer. This device configuration achieves a high luminance of several hundred cd/m² at an applied voltage of 20 V or less.

It has been reported in non-patent document 1 that a luminous efficiency of about 40 lm/W or more is achieved at a luminance equal to or less than several thousand cd/m² by using an iridium complex (phosphorescent dopant) for the emitting layer.

[Patent document 1] JP-A-63-295695

[Non-patent document 1] T. Tsutsui et. al., Jpn. J. Appl. Phys. Vol. 38 (1999), pp. L1502 to L1504

Since most of these phosphorescent organic EL devices emit green or red light, an increase in the number of colors and particularly an increase in blue luminous efficiency have been demanded. In particular, a blue device configuration with luminous quantum efficiency of 5% or more is rare.

When applying an organic EL device to a flat panel display or the like, the organic EL device is required to exhibit an improved luminous efficiency and reduced power consumption. However, the above device configuration has a disadvantage in that the luminous efficiency significantly decreases accompanying an increase in the luminance. Therefore, it is difficult to reduce the power consumption of the flat panel display.

The invention was achieved in view of the above-described problems. An object of the invention is to develop an organic EL device, particularly a blue organic EL device, exhibiting a high current efficiency or a high luminous efficiency.

### SUMMARY OF THE INVENTION

According to the invention, the following organic EL device is provided.
1. An organic electroluminescent device comprising:
   an anode,
   a cathode and
   a plurality of layers comprising a hole-injecting-transporting layer in contact with the anode and an emitting layer, the plurality of layers being provided between the anode and the cathode,
   a difference in ionization potential between the hole-injecting-transporting layer and the anode being more than 0.7 eV.
2. The organic electroluminescent device according to 1 wherein an organic compound forming the hole-injecting-transporting layer or the emitting layer contains a nitrogen-containing aromatic ring.
3. The organic electroluminescent device according to 2 wherein the nitrogen-containing aromatic ring contains 1 to 3 nitrogen atoms in a single ring or in a single condensed ring.
4. The organic electroluminescent device according to 2 wherein the organic compound has an aromatic amine skeleton, carbazolyl skeleton, azacarbazolyl skeleton or indole skeleton.
5. The organic electroluminescent device according to 2 wherein the organic compound forming the hole-injecting-transporting layer has a quinoxaline skeleton.
6. The organic electroluminescent device according to 1 wherein at least two layers of the plurality of layers including the layer in contact with the anode each contain an organic compound having a nitrogen-containing aromatic ring.
7. The organic electroluminescent device according to any one of 1 to 6 wherein the emitting layer comprises a host material and a dopant material of a phosphorescent heavy metal complex.
8. The organic electroluminescent device according to 7 wherein a singlet energy level of an organic compound forming the hole-injecting-transporting layer is equal to or more than a singlet energy level of the host material of the emitting layer.
9. The organic electroluminescent device according to 7 wherein a lowest triplet energy level of an organic compound forming the hole-injecting-transporting layer is equal to or more than a lowest triplet energy level of the host material of the emitting layer.
10. The organic electroluminescent device according to 7 wherein a lowest triplet energy level of an organic compound forming the hole-injecting-transporting layer is equal to or more than a lowest triplet energy level of the dopant material of the phosphorescent heavy metal complex.
11. The organic electroluminescent device according to 10 wherein the lowest triplet energy level (Eg^{T} (HTL)) of the organic compound forming the hole-injecting-transporting layer and the lowest triplet energy level (Eg^{T} (complex)) of the dopant material of the phosphorescent heavy metal complex satisfy the following expression:
   Eg^{T}(HTL)≧Eg^{T}(complex)+0.2 eV.

According to the invention, an organic EL device exhibiting a high current efficiency or a high luminous efficiency can be provided.

### BRIEF DESCRIPTION OF THE DRAWINGS

FIG. 1 is a cross-sectional view showing one embodiment of an organic EL device according to the invention.

FIG. 2 is a view showing the energy level of the organic EL device in FIG. 1.

FIG. 3 is a cross-sectional view showing another embodiment of an organic EL device according to the invention.

FIG. 4 is a view showing the energy level of the organic EL device in FIG. 3.

### DESCRIPTION OF THE PREFERRED EMBODIMENTS

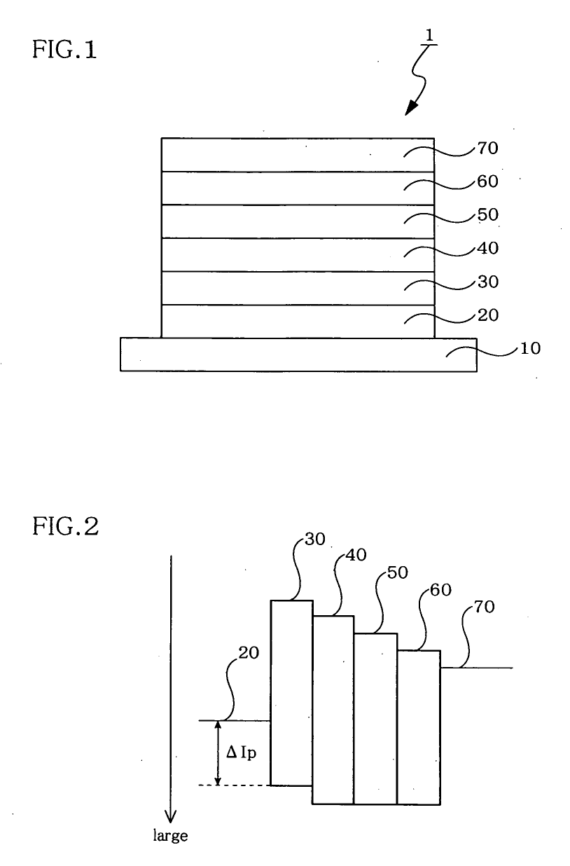

FIG. 1 is a cross-sectional view showing one embodiment of an organic EL device according to the invention.

An organic EL device 1 has a configuration in which an anode 20, a hole-injecting-transporting layer 30, an emitting layer 40, an electron transporting layer 50, an electron injecting layer 60, and a cathode 70 are stacked on a substrate 10 in that order. In the organic EL device 1, holes and electrons are respectively injected from the anode 10 and the cathode 70 upon application of voltage between the electrodes, and recombine in the emitting layer 40 to emit light.

FIG. 2 is a view showing the energy level of the organic EL device 1 shown in FIG. 1.

In FIG. 2, the difference (ΔIp) between the ionization potential of the hole-injecting-transporting layer 30 and the ionization potential of the anode 20 is greater than 0.7 eV.

The difference ΔIp is preferably 0.7 eV<ΔIp<2.5 eV, more preferably 0.7 eV<ΔIp<1.5 eV, and still more preferably 0.75 eV<ΔIp<1.5 eV.

An increase in efficiency is achieved by satisfying this condition. The term “increase in efficiency” used herein refers to a decrease in driving voltage or an increase in current efficiency.

An organic compound forming the hole-injecting-transporting layer 30 is not particularly limited. The organic compound is preferably an organic compound having at least one nitrogen-containing aromatic ring.

The nitrogen-containing aromatic ring preferably has one to three nitrogen atoms on a single ring or a single condensed ring. For example, it is preferable that the organic compound have a quinoxaline skeleton, an aromatic amine skeleton, a carbazolyl skeleton, an azacarbazolyl skeleton, or an indole skeleton.

The nitrogen-containing aromatic ring is particularly preferably a five-membered ring or a six-membered ring, and more preferably a carbazolyl skeleton or a quinoxaline skeleton.

As the organic compound forming the hole-injecting-transporting layer, a host compound and a hole injecting material described later can be given.

The emitting layer 40 shown in FIG. 1 is preferably an organic layer including a host material and a dopant material which is a phosphorescent heavy metal complex. The content of the dopant material in the emitting layer 40 is preferably 0.1 to 30 wt %, and more preferably 0.1 to 20 wt %.

The host compound of the emitting layer 40 preferably includes an organic compound having a nitrogen-containing aromatic ring. The organic compound having a nitrogen-containing aromatic ring included in the hole-injecting-transporting layer 30 and the organic compound having a nitrogen-containing aromatic ring included in the emitting layer 40 may be the same or different.

A preferred energy level of the organic compound forming the hole-injecting-transporting layer 30 in this embodiment is described below.

It is preferable that the singlet energy level of the organic compound forming the hole-injecting-transporting layer 30 be equal to or higher than the singlet energy level of the host material.

It is preferable that the lowest triplet energy level of the organic compound forming the hole-injecting-transporting layer 30 be equal to or higher than the lowest triplet energy level of the host material.

It is preferable that the lowest triplet energy level of the organic compound forming the hole-injecting-transporting layer 30 be equal to or higher than the lowest triplet energy level of the dopant material. This allows a device with high current efficiency to be realized.

It is more preferable that the lowest triplet energy level (Eg^{T} (HTL)) of the organic compound forming the hole-injecting-transporting layer 30 and the lowest triplet energy level (Eg^{T} (complex)) of the dopant material which is a phosphorescent heavy metal complex satisfy the following relational expression.
Eg^{T}(HTL)≧Eg^{T}(complex)+0.2 (eV)

An increase in current efficiency can be achieved by satisfying this relational expression.

The organic compound forming the hole-injecting-transporting layer 30 is preferably the above-mentioned compound having a nitrogen-containing aromatic ring.

Satisfying the above requirements allows excitons produced in the organic compound forming the hole-injecting-transporting layer to move toward the host material. Moreover, since excitons produced in the emitting layer contribute to luminescence without moving toward the hole-injecting-transporting layer, an increase in current efficiency or efficiency is achieved.

In this embodiment, the hole-injecting-transporting layer 30 contacts the emitting layer 40. Note that another layer may be provided between the hole-injecting-transporting layer 30 and the emitting layer 40. The layers which improve carrier injecting properties of the electron transporting layer 50, the electron injecting layer 60 and the like are provided between the emitting layer 40 and the cathode 70. Note that the invention is not limited thereto.

The hole-injecting-transporting layer 30 may be formed of a plurality of layers, as described later.

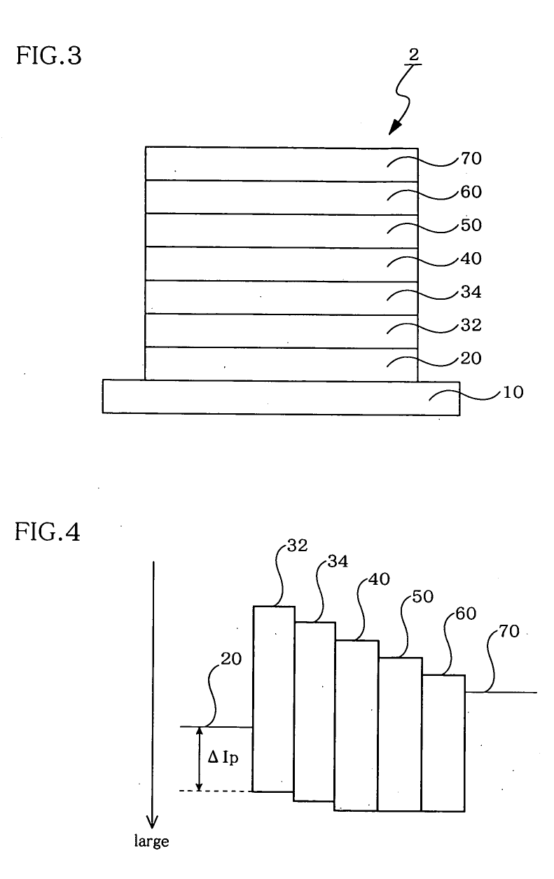

FIG. 3 is a cross-sectional view illustrating another embodiment of the organic EL device according to the invention.

An organic EL device 2 is the same as the organic EL device 1 according to the first embodiment except that the hole-injecting-transporting layer 30 is formed of a first layer 32 and a second layer 34.

FIG. 4 is a view showing the energy level of the organic EL device 1 shown in FIG. 3.

When the hole-injecting-transporting layer 30 is formed of a plurality of layers, the difference (ΔIp) between the ionization potential of the layer 32 contacting the anode 20 and the ionization potential of the anode 20 is greater than 0.7 eV, as shown in FIG. 4.

When the hole-injecting-transporting layer 30 is formed of a plurality of layers, the layer 32 contacting the anode 20 preferably includes an organic compound having a nitrogen-containing aromatic ring.

It is more preferable that the layer 32 contacting the anode 20 and the optional layer 34 each include an organic compound having a nitrogen-containing aromatic ring.

It is preferable that two or more adjacent layers include an organic compound having a nitrogen-containing aromatic ring.

The organic compounds having a nitrogen-containing aromatic ring included in the two or more layers may be the same or different.

The host compound of the emitting layer 40 preferably includes an organic compound having a nitrogen-containing aromatic ring. The organic compound having a nitrogen-containing aromatic ring included in the hole-injecting-transporting layer 30 and the organic compound having a nitrogen-containing aromatic ring included in the emitting layer 40 may be the same or different.

The organic compound having a nitrogen-containing aromatic ring is the same as the compound described in the first embodiment.

A preferred energy level of the organic compound forming the hole-injecting-transporting layer 30 is the same as in the first embodiment. When the hole-injecting-transporting layer 30 is formed of a plurality of layers as in this embodiment, the “organic compound forming the hole-injecting-transporting layer 30” means the “organic compound forming the layer 32 contacting the anode”.

In this embodiment, the hole-injecting-transporting layer 30 is formed of two layers. Note that the hole-injecting-transporting layer 30 may be formed of three or more layers.

The organic EL device according to the invention may have the following configurations in addition to the device configurations described in the above embodiments, for example.
(1) Anode/hole-injecting-transporting layer/emitting layer/cathode
(2) Anode/hole-injecting-transporting layer/emitting layer/electron transporting layer/cathode
(3) Anode/hole-injecting-transporting layer/emitting layer/electron transporting layer/electron injecting layer/cathode

The configuration (3) is preferable. The members may be stacked on the substrate in the above order or in the reverse order. It is preferable that at least one of the anode and the cathode be formed of a transparent or semitransparent substance in order to efficiently outcouple light from the organic emitting 1

Each layer is described as follows.

The dopant material included in the emitting layer is not particularly limited insofar as the dopant emits phosphorescence in the temperature range in which the device operates. Metal complexes such as Ir, Pt, Os, Pd, or Au complex are preferable. In particular, an Ir or Pt complex is preferable. Specific examples of such metal complexes are given below. 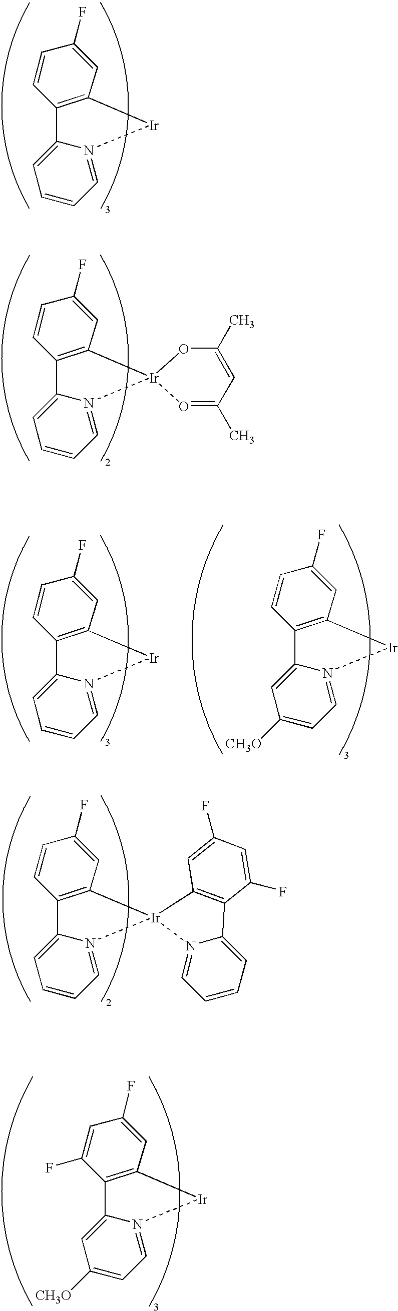 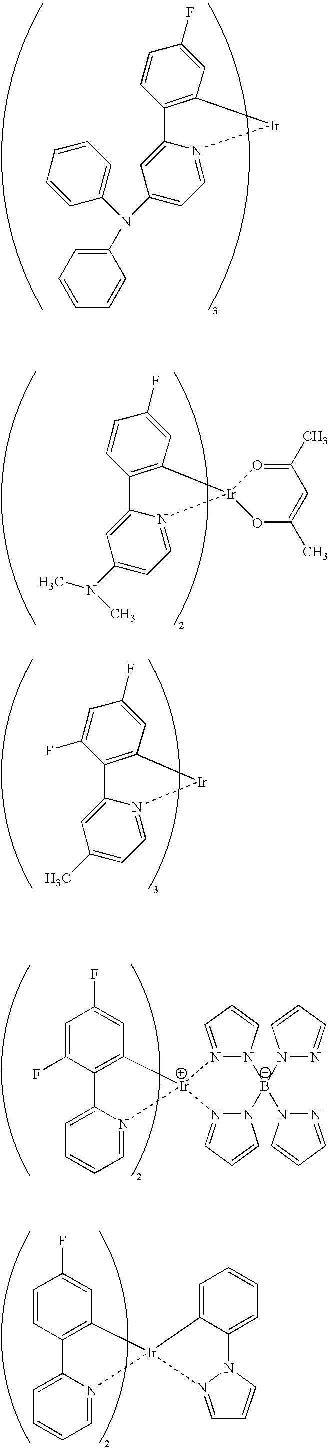 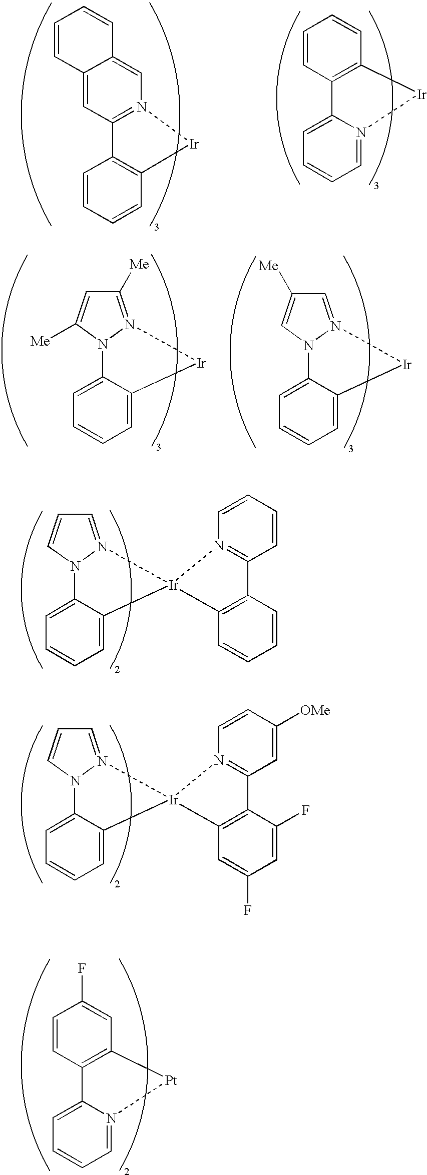
wherein Me indicates a methyl group.

Host compounds disclosed in JP-A-10-237438, JP-B-2003-042625, 2002-071398, 2002-081234, 2002-299814 and 2002-360134 may be used. Specific examples of the compounds are given below.

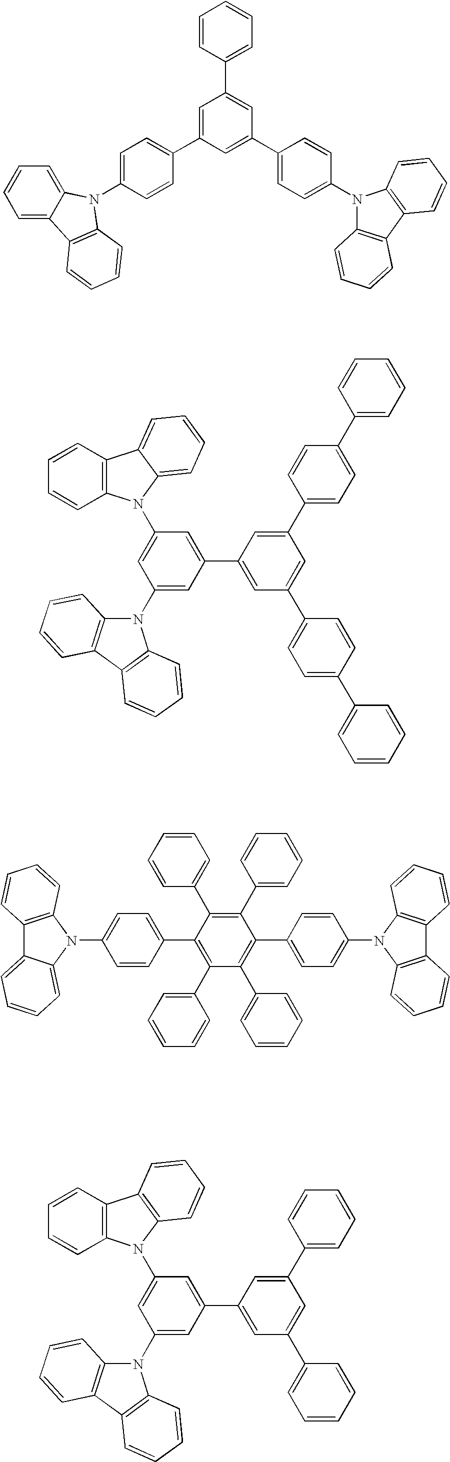

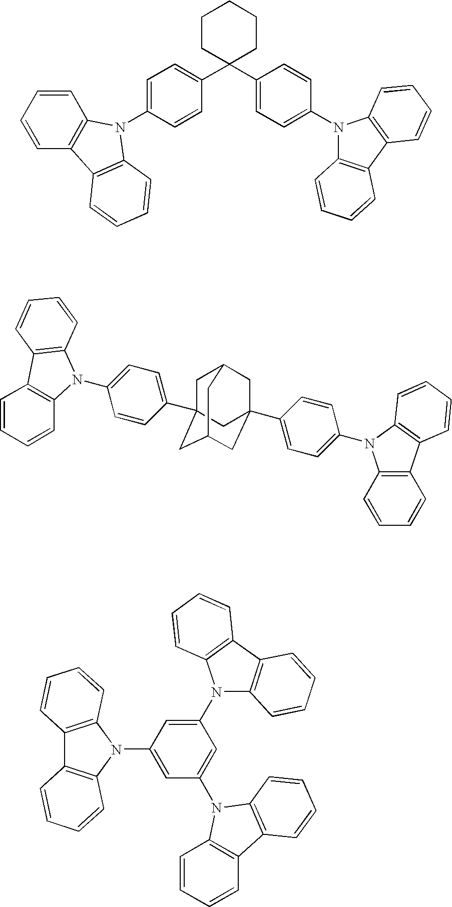

The hole-injecting-transporting layer is not limited insofar as the layer has a function of injecting holes from the anode, a function of transporting holes, or a function of blocking electrons injected from the cathode. As specific examples, carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, polysilane compounds, poly(N-vinylcarbazole) derivatives, aniline copolymers, conductive high-molecular-weight oligomers such as thiophene oligomers and polythiophene, organosilane derivatives, and the like can be given. The hole-injecting-transporting layer may have a single-layer structure formed of one, or two or more of the materials, or may have a multilayer structure formed of a plurality of layers of the same composition or different compositions.

The hole-injecting-transporting layer particularly preferably contains a carbazolyl group or m-bonding-position. This increases the singlet energy level and the triplet energy level of the compound, whereby efficiency is increased. In more detail, it is preferable to use a compound disclosed in JP-A-2002-203683 as the compound forming the hole-injecting-transporting layer contacting the anode.

For example, compounds disclosed in JP-A-2002-203683 are preferably given. Specifically the following compounds are also given.

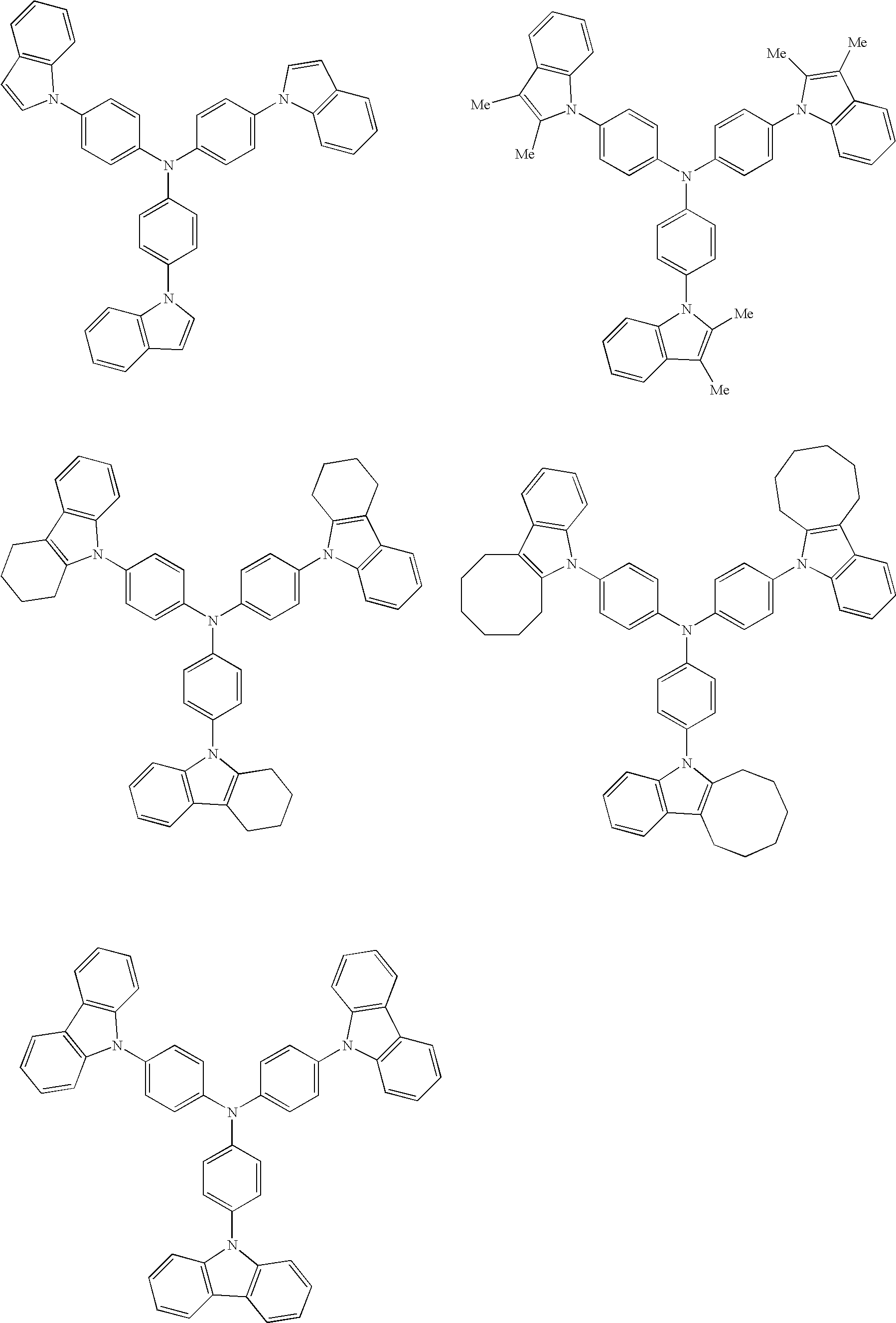

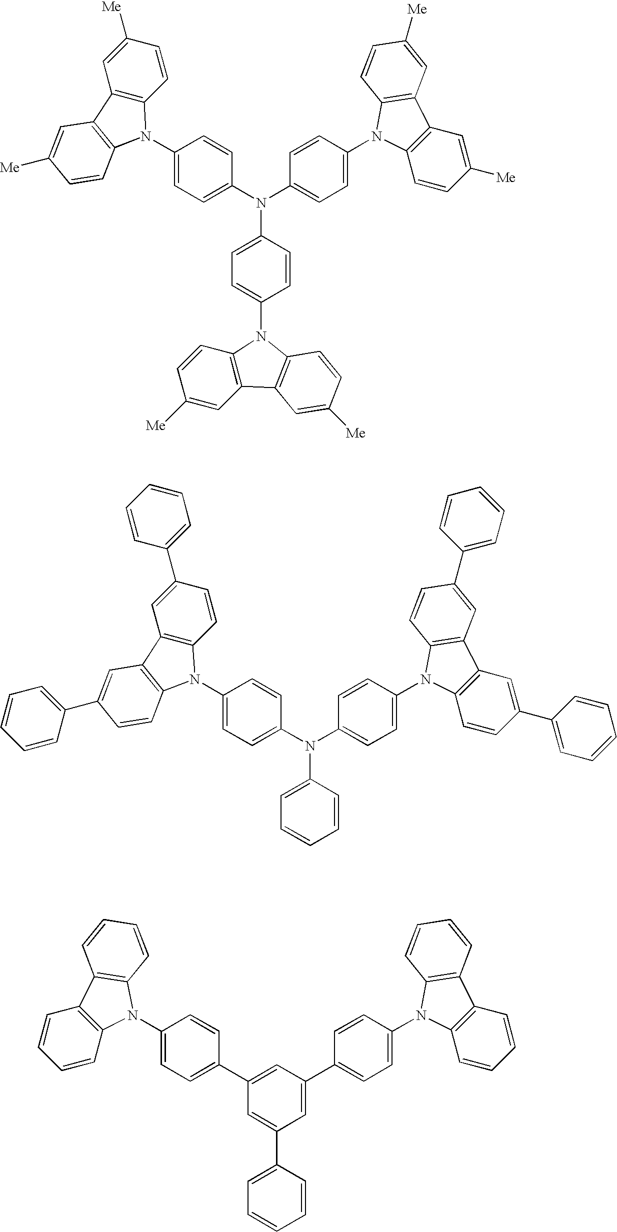

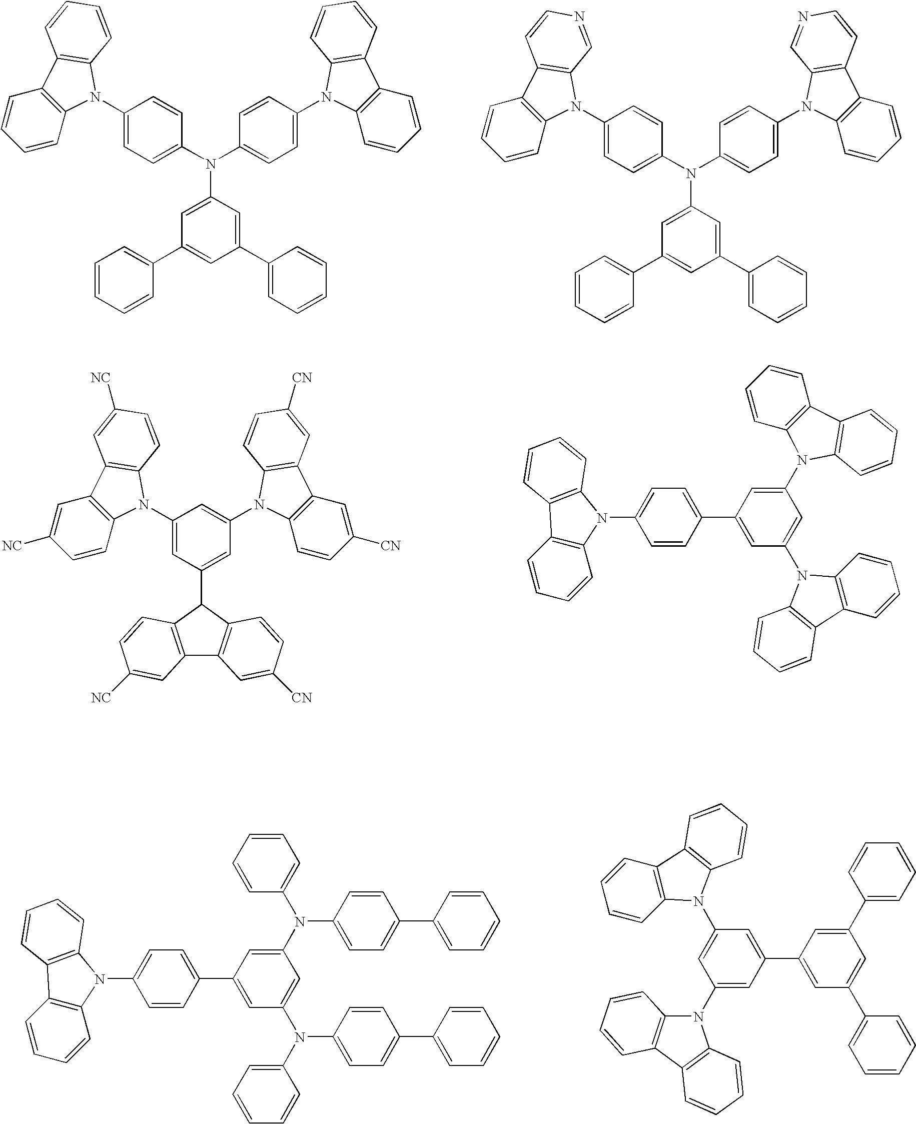

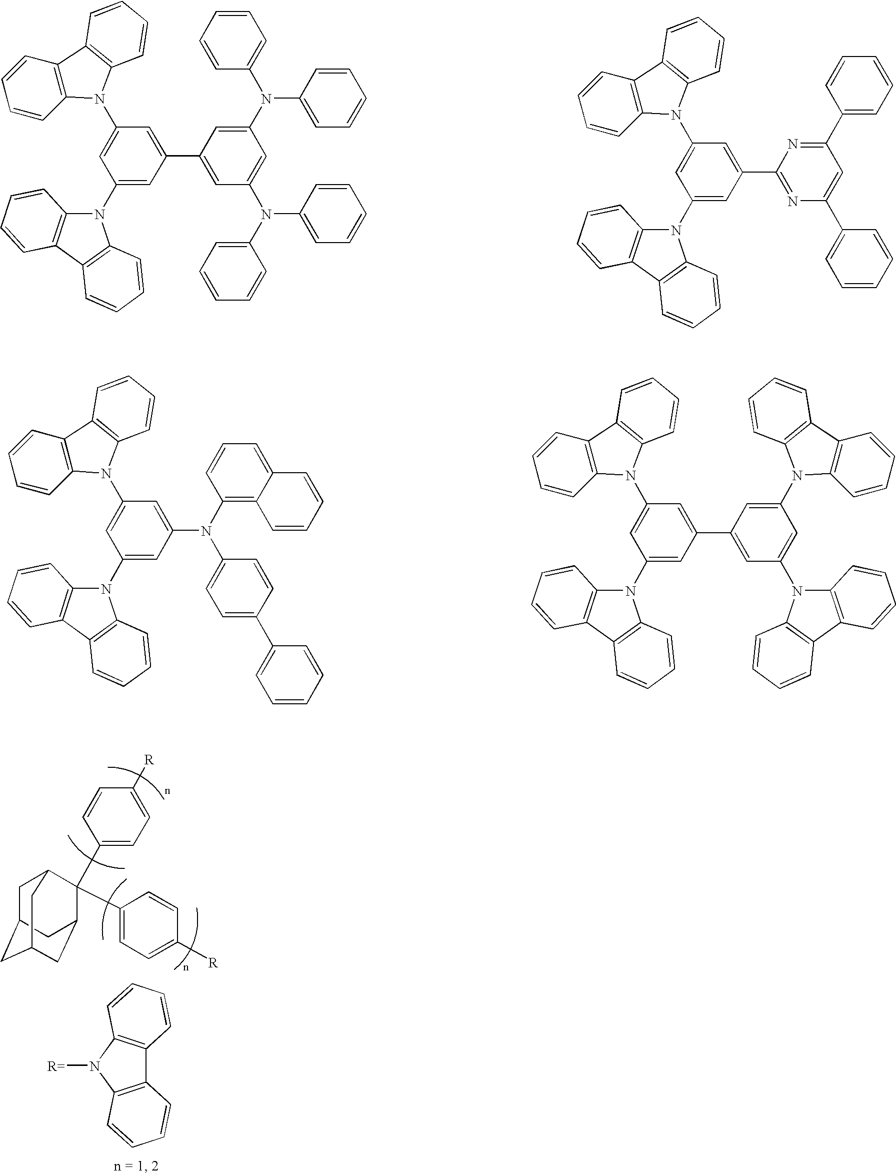

An electron transporting layer may be provided in order to increase the efficiency of a device as required. The electron injecting layer and electron transporting layer may be a layer having a function of injecting electrons from the cathode, a function of transporting electrons, or a function of blocking holes injected from the anode. As examples of the compound, triazole derivatives, oxazole derivatives, oxadiazole derivatives, imidazole derivatives, carbazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, aromatic tetracarboxylic anhydrides such as naphthalene and perylene, various metal complexes represented by metal complexes of a phthalocyanine derivative and 8-quinolinol derivative and metal complexes having metal phthalocyanine, benzoxazole, or benzothiazole as the ligand, organosilane derivatives, and the like can be given. The electron injecting laeyr and electron transporting layer may have a single-layer structure formed of one, or two or more of the above materials, or may have a multilayer structure formed of a plurality of layers of the same composition or different compositions.

In the organic EL device according to the invention, it is preferable that at least one of the electron injecting and electron transporting layers be made of a compound having a Π-electron-deficient nitrogen-containing hetero ring in the molecular skeleton.

As preferred examples of the Π-electron-deficient nitrogen-containing hetero ring derivative, a derivative of a nitrogen-containing five-membered ring selected from a benzimidazole ring, a benzotriazole ring, a pyridinoimidazole ring, a pyrimidinoimidazole ring, and a pyridazinoimidazole ring, and a nitrogen-containing six-membered ring derivative containing a pyridine ring, a pyrimidine ring, a pyrazine ring, or a triazine ring can be given.

A compound having a carbazolyl group and a compound having a three-valent nitrogen-containing hetero ring are preferable. Specifically, a compound having one carbazolyl group and a three-valent nitrogen-containing hetero ring. A compound preferably includes a m-bonding-position in a molecular skeleton to obtain a high singlet energy level and triplet energy level.

Examples of the compounds mentioned above are given below.

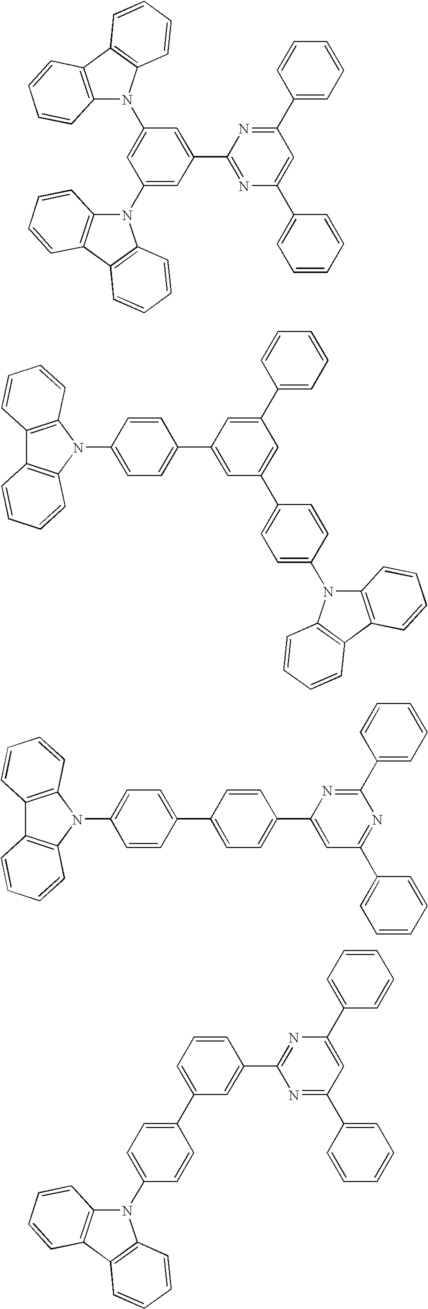

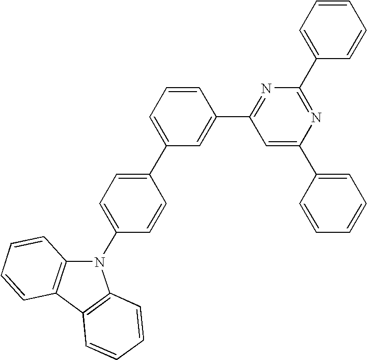

The organic EL device of the invention preferably uses an insulative or semiconductive inorganic compound as a material for forming a hole or electron injecting/transporting layer. A hole or electron injecting/transporting layer formed with a semiconductor can improve hole or electron injecting properties by efficiently preventing current leakage.

The organic EL device according to the invention is preferably supported on a substrate. The material for the substrate is not particularly limited. A known material used for an organic EL device such as glass, transparent plastic, or quartz may be used.

As the material for the anode, a metal, an alloy, or an electric conductive compound having a large work function of 4 eV or more, or a mixture of these materials is preferably used. As specific examples thereof, metals such as Au and dielectric transparent materials such as CuI, ITO, SnO₂, and ZnO can be given. The anode may be formed by forming a thin film of the above material by deposition, sputtering, or the like. When outcoupling light from the organic emitting layer through the anode, it is preferable that the anode have a transmittance of more than 10%. The sheet resistance of the anode is preferably several hundred ohm/square or less. The thickness of the anode is usually 10 nm to 1 μm, and preferably 10 to 200 nm, although the thickness varies depending on the material.

As the material for the cathode, a metal, an alloy, or an electric conductive compound having a small work function of 4 eV or less, or a mixture of these materials is preferably used. As specific examples of such a material, sodium, lithium, aluminum, a magnesium/silver mixture, a magnesium/copper mixture, Al/Al₂O₃, indium, and the like can be given. The cathode may be formed by forming a thin film of the above material by deposition, sputtering, or the like. When outcoupling light from the organic emitting layer through the cathode, it is preferable that the cathode have a transmittance of more than 10%. The sheet resistance of the cathode is preferably several hundred ohm/square or less. The thickness of the cathode is usually 10 nm to 1 μm, and preferably 50 to 200 nm, although the thickness varies depending on the material.

In the organic EL device according to the invention, an inorganic material may be added to the hole-injecting-transporting layer and the electron transporting layer, as required, in order to further increase current efficiency or luminous efficiency. An inorganic material may be preferably used for the hole-injecting-transporting layer.

An inorganic material may be used between the electron-transporting layer and the metal cathode in order to further increase current (luminous) efficiency. As specific examples of the inorganic material, fluorides and oxides of alkali metals such as Li, Mg, and Cs can be given. As examples of a semiconductor forming the electron injecting/transporting layer, a single material or a combination of two or more of an oxide, nitride, or oxynitride containing at least one element selected from Ba, Ca, Sr, Yb, Al, Ga, In, Li, Na, Cd, Mg, Si, Ta, Sb, and Zn, and the like can be given. It is preferable that the inorganic compound forming the electron transporting layer be a microcrystalline or amorphous insulating thin film. If the electron transporting layer is formed of such an insulating thin film, a more uniform thin film is formed, whereby pixel defects such as dark spots can be reduced. As examples of such an inorganic compound, the above alkali metal chalcogenides, alkaline earth metal chalcogenides, alkali metal halides, and alkaline earth metal halides can be given.

In the organic EL device according to the invention, at least one of the electron injecting and transporting layers may include a reducing dopant with a work function of 2.9 eV or less. In the invention, the reducing dopant is a compound which increases electron injecting efficiency.

In the invention, it is preferable that the reducing dopant be added to the interfacial region between the cathode and the organic thin film layer so that the reducing dopant reduces at least part of the organic layer contained in the interfacial region to produce anions. A preferred reducing dopant is at least one compound selected from the group consisting of an alkali metal, an alkaline earth metal oxide, an alkaline earth metal, a rare earth metal, an alkali metal oxide, an alkali metal halide, an alkaline earth metal oxide, an alkaline earth metal halide, a rare earth metal oxide, a rare earth metal halide, an alkali metal complex, an alkaline earth metal complex, and a rare earth metal complex.

As examples of preferred reducing dopants, at least one alkali metal selected from the group consisting of Na (work function: 2.36 eV),. K (work function: 2.28 eV), Rb (work function: 2.16 eV), and Cs (work function: 1.95 eV), and at least one alkaline earth metal selected from the group consisting of Ca (work function: 2.9 eV), Sr (work function: 2.0 to 2.5 eV), and Ba (work function: 2.52 eV) can be given. A material with a work function of 2.9 eV is particularly preferable. The reducing dopant is preferably at least one alkali metal selected from the group consisting of K, Rb, and Cs, more preferably Rb or Cs, and particularly preferably Cs. These alkali metals exhibit a particularly high reducing capability so that an increase in the luminance and the lifetime of the organic EL device can be achieved by adding a relatively small amount of alkali metal to the electron injecting region.

As the alkaline earth metal oxide, BaO, SrO, CaO, BaₓSr₁₋ₓO (0<x<1), and BaₓCa₁₋ₓO (0<x<1) are preferable.

As examples of the alkali oxide or alkali fluoride, LiF, Li₂O, NaF, and the like can be given. The alkali metal complex, the alkaline earth metal complex, and the rare earth metal complex are not particularly limited insofar as the complex contains at least one of an alkali metal ion, an alkaline earth metal ion, and a rare earth metal ion as the metal ion. As examples of the ligand, quinolinol, benzoquinolinol, acridinol, phenanthridinol, hydroxyphenyloxazole, hydroxyphenylthiazole, hydroxydiaryloxadiazole, hydroxydiarylthiadiazole, hydroxyphenylpyridine, hydroxyphenylbenzimidazole, hydroxybenzotriazole, hydroxyfurborane, bipyridyl, phenanthroline, phthalocyanine, porphyrin, cyclopentadiene, β-diketone, azomethine, derivatives thereof, and the like can be given. Note that the ligand is not limited thereto.

The reducing dopant is preferably formed in the shape of a layer or islands. The thickness of the reducing dopant is preferably 0.05 to 8 nm when used in the shape of a layer.

As the method of forming the electron transporting layer including the reducing dopant, a method is preferable in which an organic material which is the emitting material or the electron injecting material which forms the interfacial region is simultaneously deposited while depositing the reducing dopant by resistance heating deposition to disperse the reducing dopant in the organic material. The dispersion concentration (molar ratio) is 100:1 to 1:100, and preferably 5:1 to 1:5. When forming the reducing dopant in the shape of a layer, the emitting material or the electron injecting material for the organic layer at the interface is formed in the shape of a layer, and thereafter the reducing dopant is deposited by resistance heating deposition to a thickness of preferably 0.5 nm to 15 nm. When forming the reducing dopant in the shape of islands, after forming the emitting material or the electron injecting material for the organic layer at the interface, the reducing dopant is deposited by resistance heating deposition to a thickness of preferably 0.05 to 1 nm.

A method of fabricating the organic EL device according to the invention is not particularly limited. The organic EL device according to the invention may be fabricated using a conventional fabrication method used for an organic EL device. In more detail, the device may be formed by vacuum deposition, casting, coating, spin coating, or the like.

The thickness of each layer is not particularly limited, but preferably 1 nm to 1 μm and more preferably 5 to 500 nm.

The thickness of each concentration range in an emitting layer is preferably 5 nm or more. In order to function as a layer providing plane emission, a continuous film is needed; however, if the thickness is less than 5 nm, plane emission may not be obtained and the emission may be nonuniform. The thickness of whole the emitting layer is preferably 15 nm to 100 nm.

### EXAMPLES

Compounds of the following formulas were used in the examples and the comparative examples. The properties of these compounds were measured using the following methods. The results are shown in Table 1.

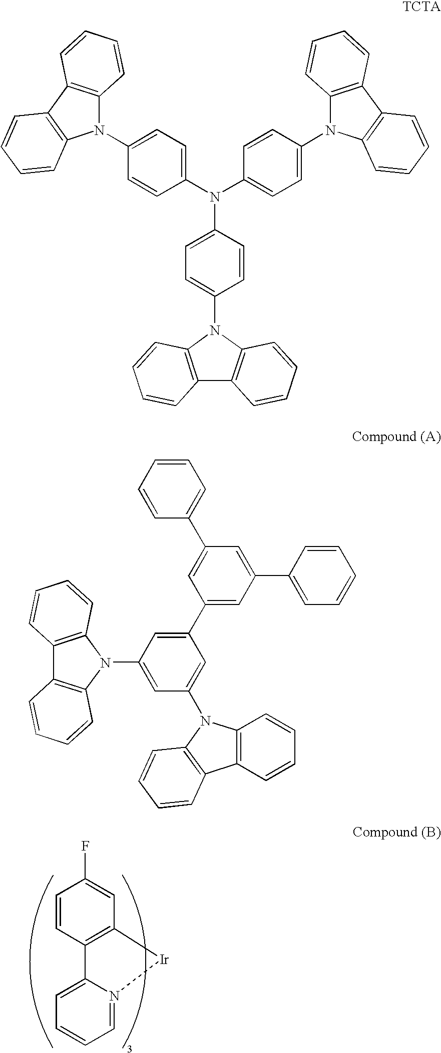

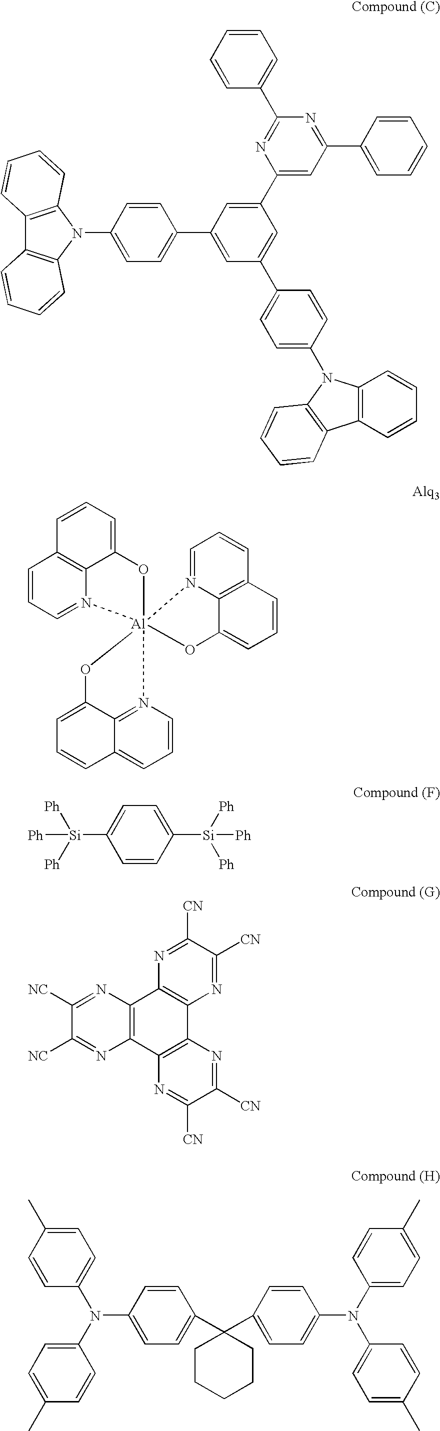

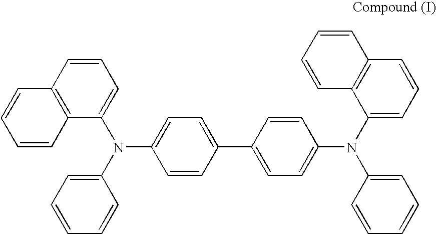

wherein Ph is a phenyl group.

(1) Ionization Potential

The ionization potential can be measured as follows. Light (excitation light) dispersed through a monochromator from a deuterium lamp is applied to a sample. The resulting photoelectric emission is measured using an electrometer, and the photoelectric emission threshold from the resulting photoelectric emission photon energy curve is calculated using an extrapolation method. The ionization potential can be measured using a commercially available atmosphere ultraviolet photoelectron spectrometer AC-1 (manufactured by Riken Keiki Co., Ltd.), for example.

In more detail, a glass substrate was subjected to ultrasonic cleaning, for five minutes in isopropyl alcohol, five minutes in water, and five minutes in isopropyl alcohol, and then subjected to UV cleaning for 30 minutes. A thin film sample to be measured was formed on the cleaned glass substrate using a vacuum deposition device. The film sample was formed to a thickness of 2000 Å using an SGC-8MII manufactured by Showa Shinku Co., Ltd. at a final vacuum of 5.3×10⁴ Pa or less and a deposition rate of 2 Å/sec.

The ionization potential was measured using an atmospheric photoelectron spectrometer (AC-1 manufactured by Riken Keiki Co., Ltd.). Light obtained by dispersing ultraviolet rays from a deuterium lamp using a spectroscope was applied to the thin film sample, and the emitted photoelectrons were measured using an open counter.

When the ionization potential was 6.0 eV or less, the intersection of the background and the square root of the quantum efficiency in the photoelectron spectrum in which the square root of the quantum efficiency was plotted along the vertical axis and the energy of applied light was plotted along the horizontal axis (measured at an interval Δ of 0.05 eV) was taken as the ionization potential.

When the ionization potential was greater than 6.0 eV, the ionization potential was determined by converting the HOMO level obtained by ultraviolet photoelectron spectroscopy (UPS) measurement.

(2) Measurement Method of Singlet Energy Level

The compound was dissolved in toluene to obtain a 10⁻⁵ mol/l solution. The absorption spectrum was measured using a spectro-photometer (U3410 manufactured by Hitachi, Ltd.). A line tangent to the UV absorption spectrum was drawn at the rising edge on the longer wavelength side, and the wavelength (absorption edge) at which the tangent line intersects the horizontal axis was determined. This wavelength was converted into an energy value to determine the singlet energy level.

(3) Measurement Method of Triplet Energy Level

The lowest excited triplet energy level T₁ was measured as follows. The lowest triplet energy level was measured with a FLUOROLOG II manufactured by SPEX at a concentration of 10 μmol/l and a temperature of 77 K using EPA (diethyl ether: isopentane: isopropyl alcohol =5:5:2 (volume ratio)) as a solvent and a quartz cell. A line 5 tangent to the resulting phosphorescence spectrum was drawn at the rising edge on the shorter wavelength side, and the wavelength (absorption edge) at which the tangent line intersects the horizontal axis was determined. This wavelength was converted into an energy value.

| | | | Lowest |
|---|---|---|---|
| | Ionization | Singlet | triplet |
| | potential | energy level | energy level |
| | (eV) | (eV) | (eV) |
| ITO | 5.0 | — | — |
| TCTA | 5.8 | 3.3 | 2.9 |
| Compound (A) | 6.0 | 3.4 | 2.9 |
| Compound (B) | 5.7 | — | 2.6 |
| Compound (C) | 6.0 | 3.9 | 2.9 |
| Alq₃ | 5.8 | 2.7 | — |
| Compound (F) | 7.18 | 4.4 | 2.89 |
| Compound (G) | 5.80 | 3.3 | 2.89 |
| Compound (H) | 5.6 | 3.4 | 2.95 |
| Compound (I) | 5.45 | 3.06 | 2.46 |

### Example 1

A glass substrate (25×75×0.7 mm) provided with an ITO transparent electrode was subjected to ultrasonic cleaning for five minutes in isopropyl alcohol and then subjected to UV ozone cleaning for 30 minutes. The cleaned glass substrate with the transparent electrode was installed in a substrate holder of a vacuum deposition device, and a TCTA film with a thickness of 95 nm was formed on the surface of the glass substrate on which the transparent electrode was formed so that the transparent electrode was covered. The TCTA film functioned as a hole-injecting-transporting layer. As a host compound, the compound (A) was deposited on the TCTA film to a thickness of 30 nm to form an emitting layer. The Ir metal complex compound (B) was added at the same time as a phosphorescent Ir metal complex dopant. The concentration of the metal complex compound (B) in the emitting layer was 7.5 wt %. This film functioned as an emitting layer. The compound (C) was deposited to a thickness of 25 nm thereon. This film functioned as an electron transporting layer. Alq₃ was further deposited to a thickness of 5 nm thereon. This film functioned as an electron transporting layer. Lithium fluoride was then deposited to a thickness of 0.1 nm, and aluminum was deposited to a thickness of 150 nm. This Al/LiF film functioned as a cathode. An organic EL device was thus fabricated.

After sealing the resulting device, electricity was supplied to the device for test. Blue green light with a luminance of 124 cd/m² was obtained at a voltage of 5.5 V and a current density of 0.43 mA/cm². The luminous efficiency was 30 cd/A. The device was driven by constant current at an initial luminance of 200 cd/m², and the time required for the luminance to decrease to 100 cd/m² was measured and the result was 1700 hours.

### Example 2

A device was fabricated in the same manner as in Example 1 except that the compound (F) was used instead of the compound (A) as a host material.

After sealing the resulting device, electricity was supplied to the device for test in the same manner as in Example 1.

Blue green light with a luminance of 108 cd/m² was obtained at a voltage of 5.8 V and a current density of 0.52 mA/cm². The luminous efficiency was 21 cd/A. The device was driven by constant current at an initial luminance of 200 cd/m², and the time required for the luminance to decrease to 100 cd/m² was measured and the result was 920 hours.

### Example 3

A device was fabricated in the same manner as in Example 1 except that the compound (G) was used instead of TCTA.

After sealing the resulting device, electricity was supplied to the device for test in the same manner as in Example 1.

Blue green light with a luminance of 110 cd/m² was obtained at a voltage of 6.0 V and a current density of 0.6 mA/cm². The luminous efficiency was 18 cd/A. The device was driven by constant current at an initial luminance of 200 cd/m² and the time required for the luminance to decrease to 100 cd/m² was measured and the result was 700 hours.

### Comparative Example 1

A device was fabricated in the same manner as in Example 1 except that the compound (H) was used instead of TCTA.

After sealing the resulting device, electricity was supplied to the device for test in the same manner as in Example 1.

Blue green light with a luminance of 98 cd/m² was obtained at a voltage of 6.5 V and a current density of 1 mA/cm². The luminous efficiency was 9.8 cd/A. The device was driven by constant current at an initial luminance of 200 cd/m², and the time required for the luminance to decrease to 100 cd/m² was measured and the result was 100 hours.

### Comparative Example 2

The cleaned glass substrate with the transparent electrode was installed in a substrate holder of a vacuum deposition device, and the compound (I) was deposited in a thickness of 5 nm on the surface of the glass substrate on which the transparent electrode was formed so that the transparent electrode was covered. The film functioned as a hole-injecting-transporting layer. A TCTA film with a thickness of 90 nm was formed on the film. This film functioned as a hole-injecting-transporting layer.

Thereafter, a device was fabricated in the same steps as in Example 1.

After sealing the resulting device, the initial emission test was carried out in the same manner as in Example 1.

Blue green light with a luminance of 110 cd/m² was obtained at a voltage of 10 V and a current density of 10 mA/cm². The luminous efficiency was 1.1 cd/A.

Comparing to the examples, the driving voltage increased by at least 4 V to obtain a luminance of 100 cd/m² to 125 cd/m² and the current efficiency also decreased from 30, 21 and 18 cd/A to 1.1 cd/A.

| | | | Hole-injecting- | | | | | | | | | |
|---|---|---|---|---|---|---|---|---|---|---|---|---|
| | | | transporting | | | | | | | | | |
| | Anode | | layer | | | | | | | | | |
| | | Ionization | | Ionization | Emit- | Electron | | Current | | Current | Initial | Half |
| | Com- | potential | Com- | potential | ting | transporting | Voltage | Density | Luminance | efficiency | luminance | time |
| | pound | (eV) | pound | (eV) | layer | layer | (V) | (mA/cm2) | (cd/m2) | (cd/A) | (cd/m2) | (hour) |
| Example 1 | ITO | 5.0 | TCTA | 5.8 | (A) | (C) | 5.5 | 0.43 | 124 | 30 | 200 | 1700 |
| | | | | | (B) | Alq₃ | | | | | | |
| Example 2 | ITO | 5.0 | TCTA | 5.8 | (F) | (C) | 5.8 | 0.52 | 108 | 21 | 200 | 920 |
| | | | | | (B) | Alq₃ | | | | | | |
| Example 3 | ITO | 5.0 | (G) | 5.8 | (A) | (C) | 6.0 | 0.6 | 110 | 18 | 200 | 700 |
| | | | | | (B) | Alq₃ | | | | | | |
| Comparative | ITO | 5.0 | (H) | 5.6 | (A) | (C) | 6.5 | 1 | 98 | 9.8 | 200 | 100 |
| example 1 | | | | | (B) | Alq₃ | | | | | | |
| Comparative | ITO | 5.0 | (I) | 5.45 | (A) | (C) | 10 | 10 | 110 | 1.1 | — | — |
| example 2 | | | TCTA | 5.8 | (B) | Alq₃ | | | | | | |

### INDUSTRIAL APPLICABILITY

The blue organic EL device according to the invention with a high luminous efficiency and a long lifetime may be used as an organic EL material of each color including blue, may be applied in various fields such as a display device, display, backlight, illumination light source, sign, signboard, and interior, and is particularly suitable as a display device for a color display.

1. An organic electroluminescent device comprising:
an anode,
a cathode and
a plurality of layers comprising a hole-injecting-transporting layer in contact with the anode and an emitting layer, the plurality of layers being provided between the anode and the cathode,
a difference in ionization potential between the hole-injecting-transporting layer and the anode being more than 0.7 eV.

2. The organic electroluminescent device according to claim 1 wherein an organic compound forming the hole-injecting-transporting layer or the emitting layer contains a nitrogen-containing aromatic ring.

3. The organic electroluminescent device according to claim 2 wherein the nitrogen-containing aromatic ring contains 1 to 3 nitrogen atoms in a single ring or in a single condensed ring.

4. The organic electroluminescent device according to claim 2 wherein the organic compound has an aromatic amine skeleton, carbazolyl skeleton, azacarbazolyl skeleton or indole skeleton.

5. The organic electroluminescent device according to claim 2 wherein the organic compound forming the hole-injecting-transporting layer has a quinoxaline skeleton.

6. The organic electroluminescent device according to claim 1 wherein at least two layers of the plurality of layers including the layer in contact with the anode each contain an organic compound having a nitrogen-containing aromatic ring.

7. The organic electroluminescent device according to claim 1 wherein the emitting layer comprises a host material and a dopant material of a phosphorescent heavy metal complex.

8. The organic electroluminescent device according to claim 7 wherein a singlet energy level of an organic compound forming the hole-injecting-transporting layer is equal to or more than a singlet energy level of the host material of the emitting layer.

9. The organic electroluminescent device according to claim 7 wherein a lowest triplet energy level of an organic compound forming the hole-injecting-transporting layer is equal to or more than a lowest triplet energy level of the host material of the emitting layer.

10. The organic electroluminescent device according to claim 7 wherein a lowest triplet energy level of an organic compound forming the hole-injecting-transporting layer is equal to or more than a lowest triplet energy level of the dopant material of the phosphorescent heavy metal complex.

11. The organic electroluminescent device according to claim 10 wherein the lowest triplet energy level (Eg^{T} (HTL)) of the organic compound forming the hole-injecting-transporting layer and the lowest triplet energy level (Eg^{T}(complex)) of the dopant material of the phosphorescent heavy metal complex satisfy the following expression:
Eg^{T}(HTL)≧Eg^{T}(complex)+0.2 eV.
